(19) United States
(12) Patent Application Publication
(10) Pub. No.: US 2023/0183943 A1
(43) Pub. Date: Jun. 15, 2023

(54) SYSTEM AND METHOD FOR CONTROLLING WORK MACHINE

(71) Applicant: KOMATSU LTD., Tokyo (JP)

(72) Inventors: Yuuichi KADONO, Tokyo (JP); Yukihisa TAKAOKA, Tokyo (JP)

(21) Appl. No.: 17/924,034

(22) PCT Filed: Jun. 9, 2021
(86) PCT No.: PCT/JP2021/021842

§ 371 Date: Nov. 8, 2022

(30) Foreign Application Priority Data
Jul. 20, 2020 (JP) 2020-123915

(51) Int. Cl. E02F 9/20

(52) U.S. Cl. CPC E02F 9/2054; E02F 9/205; E02F 3/841

(57) ABSTRACT

A system includes a plurality of work machines, a communication device, an operating device, and a controller. The plurality of work machines are able to operate automatically. The plurality of work machines include a first work machine and a second work machine. The communication device communicates wirelessly with the plurality of work machines. The operating device transmits an operation signal to the plurality of work machines via the communication device. The operating device is able to operate the plurality of work machines remotely and individually. The controller disables the operation of the operating device on the first work machine when the first work machine and the second work machine are operating automatically.

### CROSS-REFERENCE TO RELATED APPLICATIONS

This application is a U.S. National stage application of International Application No. PCT/JP2021/021842, filed on Jun. 9, 2021. This U.S. National stage application claims priority under 35 U.S.C. § 119(a) to Japanese Patent Application No. 2020-123915, filed in Japan on Jul. 20, 2020, the entire contents of which are hereby incorporated herein by reference.

### BACKGROUND

### Technical Field

The present invention relates to a system and a method for controlling a work machine.

### Background Information

A plurality of work machines may work in cooperation at a work site. For example, a plurality of bulldozers cooperate to perform excavation at the same work site in U.S. Pat. No. 9,014,922. The bulldozers perform excavation while following work lanes that extend in a predetermined work direction. Recently, technologies for automatic control of work machines have been proposed. When a plurality of work machines are being used at the same time at one work site, work efficiency can be improved by automatically controlling the plurality of work machines.

### SUMMARY

It becomes difficult to automatically control a plurality of work machines when an abnormality such as a failure occurs in some of the work machines. As a result, even when a plurality of work machine are being automatically controlled, it is desirable that an operator is able to operate the work machines remotely using an operating device. However, the efficiency of the work is reduced when the automatic control of some of the work machines is canceled due to an unnecessary operation of the operating device. An object of the present disclosure is to enable an operator to use an operating device to remotely operate a plurality of work machines that are able to move automatically and also prevent a reduction in work efficiency due to an unnecessary operation.

A system according to an aspect of the present disclosure includes a plurality of work machines, a communication device, an operating device, and a controller. The plurality of work machines are able to operate automatically. The plurality of work machines include a first work machine and a second work machine. The communication device communicates wirelessly with the plurality of work machines. The operating device transmits an operation signal to the plurality of work machines via the communication device. The operating device is able to operate the plurality of work machines remotely and individually. The controller disables the operation of the operating device on the first work machine when the first work machine and the second work machine are operating automatically.

A method according to another aspect of the present disclosure is a method for controlling a plurality of work machines. The plurality of work machines are able to operate automatically. The plurality of work machines include a first work machine and a second work machine. The method according to the present aspect includes the following processes. A first process is transmitting an operation signal to the plurality of work machines from an operating device that is able to operate the plurality of work machines remotely. A second process is determining whether the first work machine and the second work machine are operating automatically. A third process is disabling the operation of the operating device on the first work machine when the first work machine and the second work machine are operating automatically.

According to the present disclosure, an operator is able to use an operating device and operate a plurality of work machines remotely. In addition, the operation of the operating device on the first work machine is disabled when the first work machine and the second work machine are operating automatically. Consequently, a reduction in work efficiency due to an unnecessary operation can be prevented.

### BRIEF DESCRIPTION OF THE DRAWINGS

FIG. 1 is a schematic view of a control system for work machines according to an embodiment.

FIG. 2 is a side view of the work machine.

FIG. 3 is a schematic view of a configuration of the work machine.

FIG. 4 is a flow chart of a process of an automatic operation.

FIG. 5 is a side view of an example of an actual topography.

FIG. 6 is a top view of a work site that represents an example of a work area.

FIG. 7 is a flow chart illustrating processing for switching from an automatic operating mode to a manual operating mode.

### DETAILED DESCRIPTION OF EMBODIMENT(S)

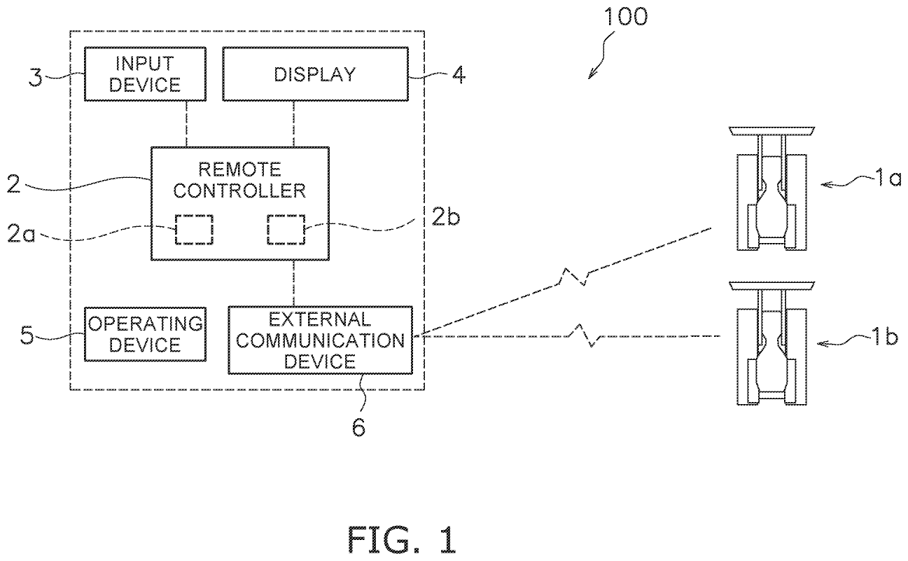

A control system for a work machine according to an embodiment is discussed hereinbelow with reference to the drawings. FIG. 1 is a schematic view of a control system 100 for work machines according to an embodiment. As illustrated in FIG. 1, the control system 100 includes a plurality of work machines 1a and 1b, a remote controller 2, an input device 3, a display 4, an operating device 5, and an external communication device 6. The control system 100 controls the work machines 1a and 1b disposed at a work site such as an excavation site. The plurality of work machines 1a and 1b include a first work machine 1a and a second work machine 1b. The work machines 1a and 1b according to the present embodiment are bulldozers.

The remote controller 2, the input device 3, the display 4, the operating device 5, and the external communication device 6 are disposed outside of the work machines 1a and 1b. The remote controller 2, the input device 3, the display 4, the operating device 5, and the external communication device 6 may be disposed, for example, at a management center outside of the work machines 1a and 1b. The remote controller 2 remotely operates the work machines 1a and 1b. The number of work machines remotely operated by the remote controller 2 is not limited to two and may be more than two machines.

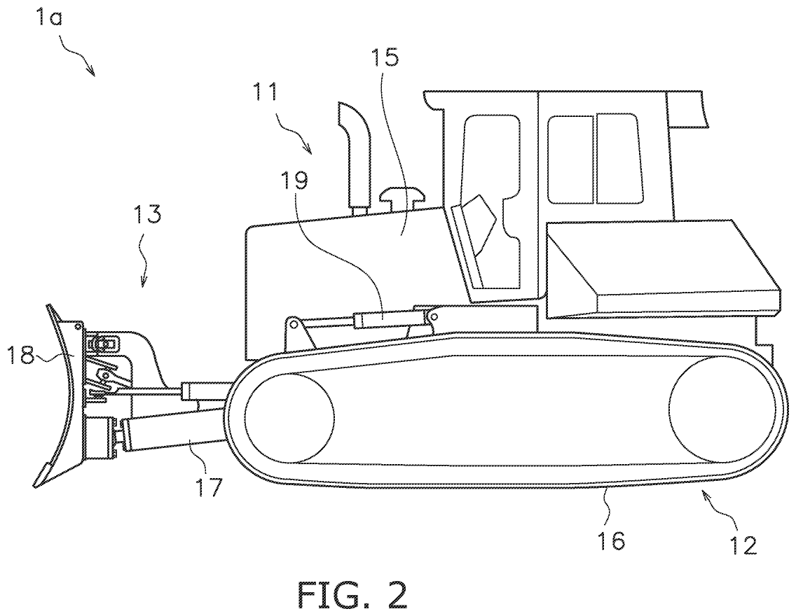

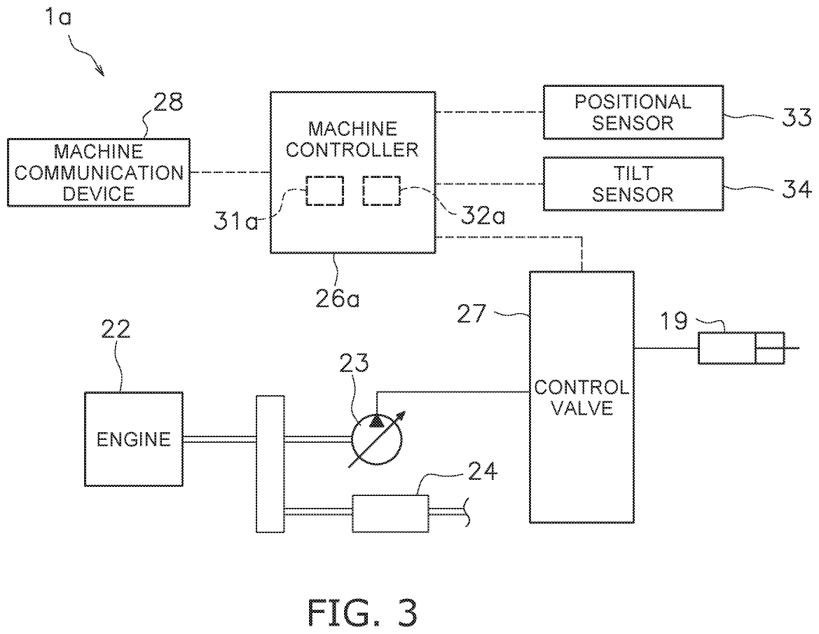

FIG. 2 is a side view of the first work machine 1a. FIG. 3 is a block diagram illustrating a configuration of the first work machine 1a. While the following explanation pertains to the first work machine 1a, the configuration of the other work machine 1b is the same as that of the first work machine 1a. As illustrated in FIG. 2, the first work machine 1a includes a vehicle body 11, a travel device 12, and a work implement 13. The vehicle body 11 includes an engine compartment 15. The travel device 12 is attached to the vehicle body 11. The travel device 12 has left and right crawler belts 16. Only the crawler belt 16 on the left side is illustrated in FIG. 2. The first work machine 1a travels due to the rotation of the crawler belts 16.

The work implement 13 is attached to the vehicle body 11. The work implement 1 includes a lift frame 17, a blade 18, and a lift cylinder 19. The lift frame 17 is attached to the vehicle body 11 in a manner that allows movement up and down. The lift frame 17 supports the blade 18. The blade 18 moves up and down accompanying the up and down movements of the lift frame 17. The lift frame 17 may be attached to the travel device 12. The lift cylinder 19 is coupled to the vehicle body 11 and the lift frame 17. Due to the extension and contraction of the lift cylinder 19, the lift frame 17 moves up and down.

As illustrated in FIG. 3, the first work machine 1a includes an engine 22, a hydraulic pump 23, a power transmission device 24, and a control valve 27. The hydraulic pump 23 is driven by the engine 22 to discharge hydraulic fluid. The hydraulic fluid discharged from the hydraulic pump 23 is supplied to the lift cylinder 19. While only one hydraulic pump 23 is illustrated in FIG. 3, a plurality of hydraulic pumps may be provided.

The power transmission device 24 transmits the driving power of the engine 22 to the travel device 12. The power transmission device 24 may be, for example, a hydrostatic transmission (HST). Alternatively, the power transmission device 24 may be, for example, a transmission having a torque converter or a plurality of speed change gears. Alternatively, the power transmission device may be another type of transmission.

The control valve 27 is disposed between the hydraulic pump 23 and a hydraulic actuator such as the lift cylinder 19. The control valve 27 controls the flow rate of the hydraulic fluid supplied to the lift cylinder 19. The control valve 27 may be a pressure proportional control valve. Alternatively, the control valve 27 may be an electromagnetic proportional control valve.

The first work machine 1a includes a machine controller 26a and a machine communication device 28. The machine controller 26a controls the travel device 12 or the power transmission device 24 thereby enabling the first work machine 1a to travel. The machine controller 26a controls the control valve 27 whereby the blade 18 is moved up and down.

The machine controller 26a is programmed to control the first work machine 1a based on acquired data. The machine controller 26a includes a processor 31a and a storage device 32a. The processor 31a may be, for example, a central processing unit (CPU). Alternatively, the processor 31a may be a processor different from a CPU. The processor 31a executes processing for controlling the first work machine 1a in accordance with a program.

The storage device 32a includes a non-volatile memory such as a ROM and a volatile memory such as a RAM. The storage device 32a may include an auxiliary storage device such as a hard disk or a solid state drive (SSD). The storage device 32a is an example of a non-transitory computer-readable recording medium. The storage device 32a stores computer commands and data for controlling the first work machine la.

The machine communication device 28 communicates wirelessly with the external communication device 6. For example, the machine communication device 28 communicates with the external communication device 6 through a wireless LAN such as Wi-Fi (trademark), a mobile communication such as 3G, 4G, or 5G, or another type of wireless communication system.

The first work machine 1a includes a positional sensor 33. The positional sensor 33 may include, for example, a global navigation satellite system (GNSS) receiver such as a global positioning system (GPS). Alternatively, the positional sensor 33 may include a receiver of another type of positioning system. The positional sensor 33 may include a ranging sensor such as LIDAR or an image sensor such as a stereo camera. The positional sensor 33 outputs position data to the machine controller 26a. The position data indicates the position of the first work machine la.

The first work machine 1a includes a tilt sensor 34. The tilt sensor 34 detects the tilt of the first work machine 1a. The tilt sensor 34 includes, for example, an inertial measurement unit (IMU). The tilt of the first work machine 1a indicates the tilt of the vehicle body 11. The tilt of the first work machine 1a includes a roll angle and a pitch angle of the vehicle body 11. The roll angle is an angle in the right-left direction of the vehicle body 11 with respect to the horizontal direction. The pitch angle is an angle in the front-back direction of the vehicle body 11 with respect to the horizontal direction. The tilt sensor 34 outputs machine tilt data that indicates the tilt of the first work machine 1a.

The external communication device 6 illustrated in FIG. 1 communicates wirelessly with the machine communication device 28. The external communication device 6 transmits a command signal from the remote controller 2 to the machine communication device 28. The machine controller 26a receives the command signal via the machine communication device 28. The external communication device 6 receives the position data and the machine tilt data of the first work machine 1a via the machine communication device 28.

The input device 3 is a device that can be operated by an operator. The input device 3 receives an input command from the operator and outputs an operation signal corresponding to the input command to the remote controller 2. The input device 3 outputs an operation signal corresponding to an operation by the operator. The input device 3 outputs the operation signal to the remote controller 2. The input device 3 may include, for example, a pointing device such as a mouse or a track ball. The input device 3 may include a keyboard.

The display 4 includes a monitor such as a CRT, and LCD, or an OELD. The display 4 receives an image signal from the remote controller 2. The display 4 displays an image corresponding to the image signal. The display 4 may be integrated with the input device 3. For example, the input device 3 and the display 4 may include a touchscreen.

The operating device 5 can be operated by an operator. The operating device 5 includes, for example, a pedal, a lever, or a switch. The operating device 5 is able to operate the plurality of work machines 1a and 1b remotely and individually. The operating device 5 may be able to specify and remotely operate some of the plurality of work machines 1a and 1b. As discussed below, the work machines 1a and 1b are able to switch between an automatic operating mode and a manual operating mode.

In the automatic operating mode, the work machines 1a and 1b operate automatically without operations by the operator. In the automatic operating mode, the work machines 1a and 1b operate according to belowmentioned commands from the remote controller 2. Alternatively, in the automatic operating mode, the work machines 1a and 1b operate automatically in an independent manner. In such a situation, the work machines 1a and 1b operate according to a judgment of the machine controller of the respective work machine 1a and 1b.

In the manual operating mode, the work machines 1a and 1b operate in response to an operation signal from the operating device 5. The operating device 5 receives an operation by an operator and outputs an operation signal corresponding to the operation. The operation signals are transmitted to the plurality of work machines 1a and 1b via the external communication device 6.

The remote controller 2 remotely controls the work machines 1a and 1b. The remote controller 2 receives an operation signal from the input device 3. The remote controller 2 outputs an image signal to the display 4. The remote controller 2 includes a processor 2a and a storage device 2b. The processor 2a may be, for example, a central processing unit (CPU). Alternatively, the processor 2a may be a processor different from a CPU. The processor 2a executes processing for controlling the work machines 1a and lb in accordance with a program. In the following explanation, the disclosures relating to the processing executed by the remote controller 2 may be interpreted as processing executed by the processor 2a.

The storage device 2b includes a non-volatile memory such as a ROM and a volatile memory such as a RAM. The storage device 2b may include an auxiliary storage device such as a hard disk or a solid state drive (SSD). The storage device 2b is an example of a non-transitory computer-readable recording medium. The storage device 2b stores computer commands and data for controlling the work machines 1a and 1b.

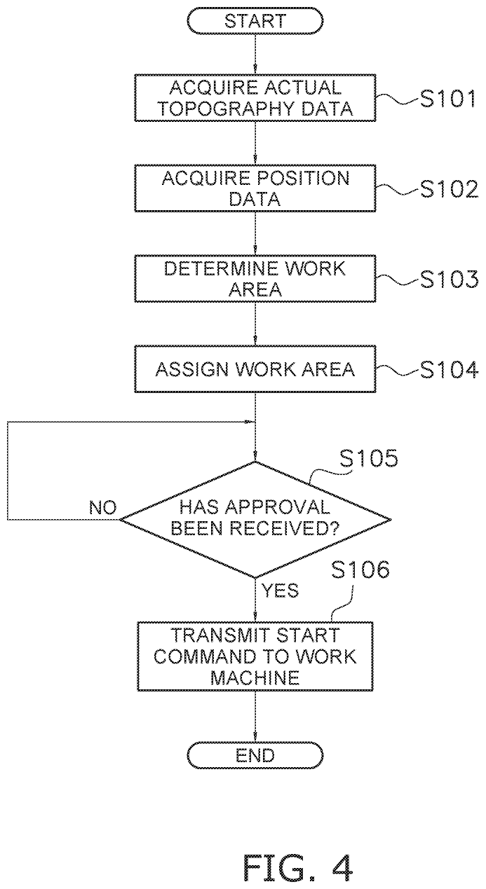

Automatic operation of the work machines 1a and 1b executed by the control system 100 will be explained next. FIG. 4 is a flow chart of processing performed by the remote controller 2.

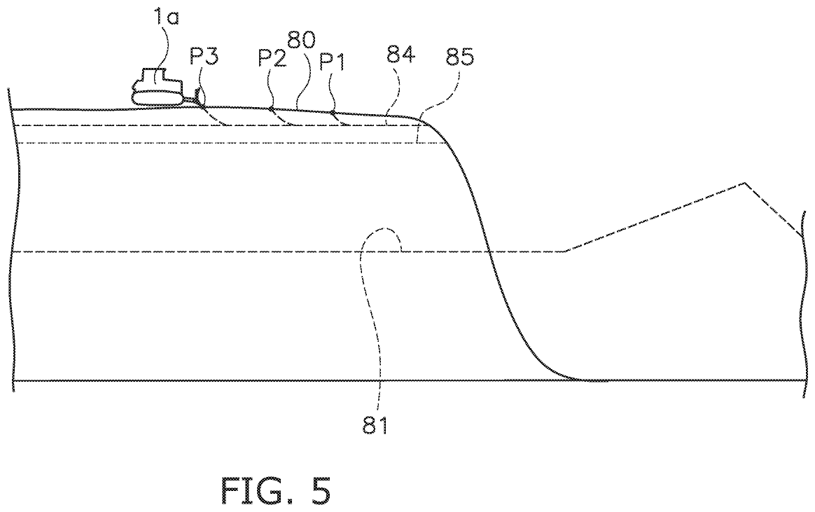

As illustrated in step S101 in FIG. 4, the remote controller 2 acquires actual topography data. The actual topography data represents the actual topography of the work site. FIG. 5 is a side view of an example of an actual topography 80. The actual topography data includes the coordinates and the height of a plurality of points on the actual topography 80. The work machines 1a and 1b excavate the actual topography 80 with the automatic control so that the actual topography 80 has a shape matching a final target topography 81.

In step S102, the remote controller 2 acquires position data. The position data includes first position data of the first work machine 1a and the second position data of the second work machine 1b. The first position data indicates the position of the first work machine 1a. The second position data indicates the position of the second work machine 1b.

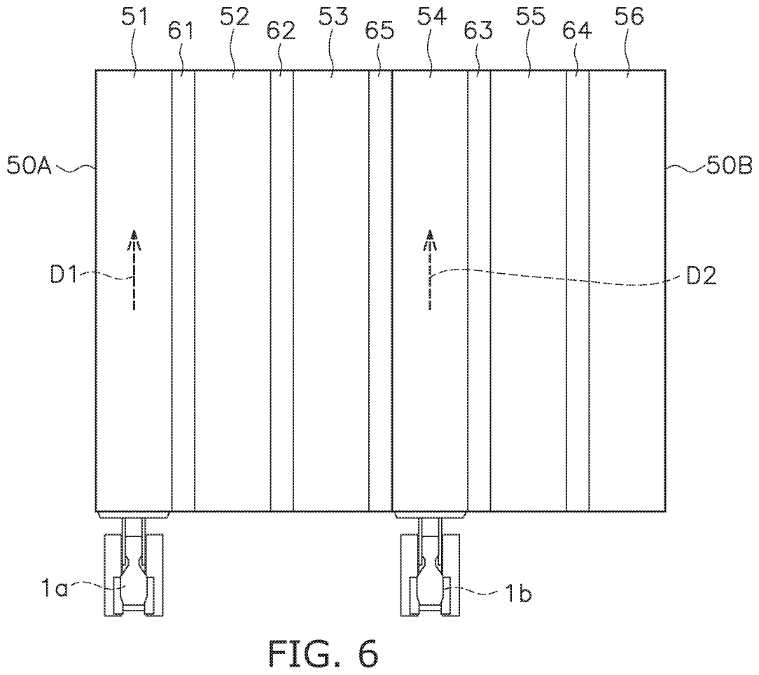

In step S103, the remote controller 2 determines a plurality of work areas 50a and 50B in the work site. FIG. 6 is a top view of the work site that represents an example of the work areas 50A and 50B according to the first embodiment. The plurality of work areas 50a and 50B include a first work area 50A and a second work area 50B. The first work area 50A includes a plurality of first work lanes 51 to 53. The plurality of first work lanes 51 to 53 extend in a predetermined first work direction D1. The plurality of first work lanes 51 to 53 extend linearly. The first work lanes 51 to 53 are aligned in the transverse direction of the first work area 50A. The transverse direction of the first work area 50A is a direction crossing the first work direction D1.

The second work area 50B includes a plurality of second work lanes 54 to 56. The plurality of second work lanes 54 to 56 extend in a predetermined second work direction D2. The plurality of second work lanes 54 to 56 extend linearly. The second work lanes 54 to 56 are aligned in the transverse direction of the second work area 50B. The transverse direction of the second work area 50B is a direction crossing the second work direction D2. In the example illustrated in FIG. 6, the first work direction D1 and the second work direction D2 are in the same direction.

The remote controller 2 may determine the work areas 50A and 50b in response to an operation of the input device 3 by the operator. Alternatively, the remote controller 2 may determine the work areas 50A and 50B automatically.

The arrangement of the work lanes 51 to 56 is not limited to that of FIG. 6 and may be changed. For example, the number of work lanes in each work area is not limited to three and may be less than three or more than three. The number of work lanes in the first work area 50A and the number of work lanes in the second work area 50B is not limited to the same number and may be different. The number of work areas is not limited to two and may be more than two.

In step S104, the remote controller 2 assigns the work areas 50A and 50B to the work machines 1a and 1b. The operator assigns each of the plurality of plurality of work areas 50a and 50B to either of the work machines la and 1b with the input device 3. The remote controller 2 determines the work machine assigned to each of the plurality of work areas 50a and 50B based on an operation signal from the input device 3.

Alternatively, the remote controller 2 may automatically determine the work machine assigned to each of the plurality of work areas 50a and 50B. In the example illustrated in FIG. 6, the remote controller 2 assigns the first work area 50A to the first work machine 1a and assigns the second work area 50B to the second work machine 1b.

In step S105, the remote controller 2 determines whether approval to start work has been received. The operator is able to indicate approval to start the work by the work machines 1a and 1b with the input device 3. The remote controller 2 determines whether the approval has been received based on an operation signal from the input device 3. The remote controller 2 may determine whether approval has been received individually for each of the work machines 1a and 1b.

In step S106, the remote controller 2 transmits a work starting command to the work machines 1a and 1b. Consequently, the first work machine 1a is controlled so as to perform work in accordance with the arrangement of the assigned first work lanes 51 to 53. The remote controller 2 transmits data indicating the positions of the first work lanes 51 to 53 to the first work machine 1a. The remote controller 2 transmits data indicating the positions of the second work lanes 54 to 56 to the second work machine 1b.

The first work machine 1a moves to the first work lanes 51 to 53 assigned to the first work machine 1a and automatically matches the position and orientation with the first work lanes 51 to 53. The first work machine 1a performs excavation while moving along the first work lanes 51 to 53. When the excavation of the first work lanes 51 to 53 is completed, excavation walls remain between the first work lanes 51 to 53. The first work machine la excavates the excavation walls while moving along areas 61 and 62 of assigned first excavation walls. The sequence for excavating the first work lanes 51 to 53 or the sequence for excavating the areas 61 and 62 of the first excavation walls may be determined by the remote controller 2. Alternatively, the sequence for excavating the first work lanes 51 to 53 or the sequence for excavating the areas 61 and 62 of the first excavation walls may be determined by the machine controller 26a of the first work machine 1a.

Similarly, the second work machine 1b moves to the second work lanes 54 to 56 assigned to the second work machine 1b and automatically matches the position and orientation with the second work lanes 54 to 56. The second work machine 1a then performs excavation while moving along the second work lanes 54 to 56. When the excavation of the second work lanes 54 to 56 is completed, excavation walls remain between the second work lanes 54 to 56. The second work machine 1b excavates the excavation walls while moving along areas 63 and 64 of assigned second excavation walls. The sequence for excavating the second work lanes 54 to 56 or the sequence for excavating the areas 63 and 64 of the second excavation walls may be determined by the remote controller 2. Alternatively, the sequence for excavating the second work lanes 54 to 56 or the sequence for excavating the areas 63 and 64 of the second excavation walls may be determined by the machine controller of the second work machine 1b.

As illustrated in FIG. 5 for example, the first work machine 1a operates the blade 18 in accordance with the target design topography 84. The first work machine 1a starts excavating while moving forward from a first start point P1 on the actual topography 80 and pushes the excavated soil over a precipice. The first work machine 1a moves backward to a second start point P2. The first work machine 1a starts excavating while moving forward from the second start point P2 and pushes the excavated soil over the precipice. The first work machine 1a moves backward to a third start point P3. The first work machine 1a starts excavating while moving forward from the third start point P3 and pushes the excavated soil over the precipice.

The first work machine 1a excavates the actual topography 80 to form a shape that matches the target design topography 84 by repeating such work. The second work machine 1b also excavates in the same way as the first work machine 1a. When the work machines 1a and 1b complete the excavation of the target design topography 84, the work machines 1a and 1b excavate a subsequent target design topography 85 positioned therebelow. The work machines 1a and 1b repeat the above work until reaching the final target topography 81 or a topography close thereto.

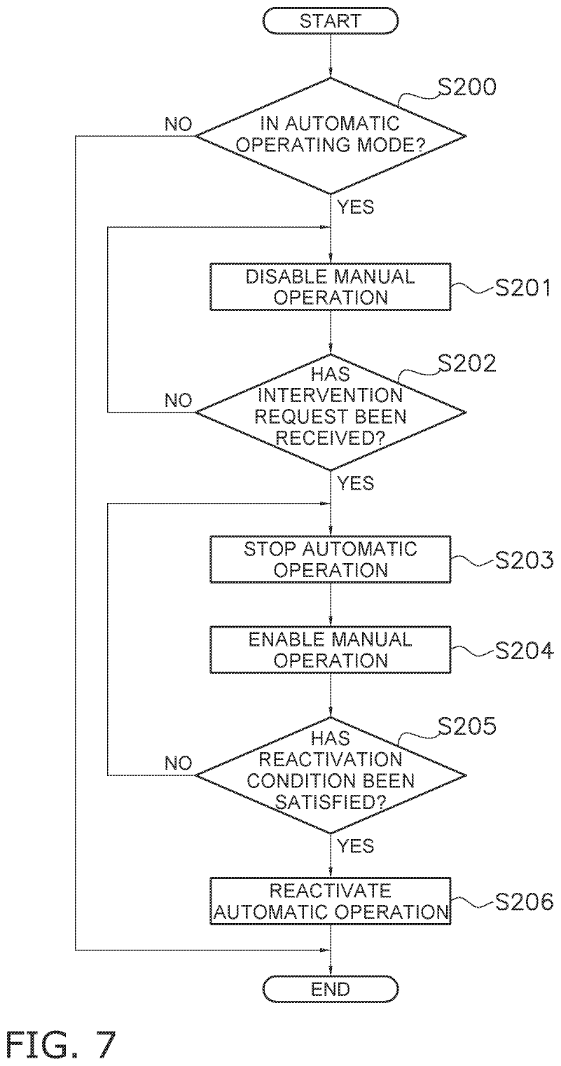

Processing for switching between the automatic operating mode and the manual operating mode will be explained next. FIG. 7 is a flow chart illustrating processing for switching from the automatic operating mode to the manual operating mode. As illustrated in FIG. 7, in step S200, the remote controller 2 determines whether the plurality of work machines 1a and 1b are in the automatic operating mode. The remote controller 2 stores whether the plurality of work machines 1a and 1b are in the automatic operating mode for each of the plurality of work machines 1a and 1b. When all of the plurality of work machines 1a and 1b are in the automatic operating mode, the routine advances to step S201.

In step S201, the remote controller 2 disables the operation with the operating device 5 on the first work machine 1a and the second work machine 1b during the automatic operating mode. Therefore, even if the operator operates the operating device 5 during the automatic operating mode, the first work machine 1a and the second work machine 1b continue to operate automatically.

In step S202, the remote controller 2 determines whether an intervention request has been received from any of the plurality of work machines 1a and 1b. The machine controllers of each of the work machines 1a and 1b detect the states of the work machines 1a and 1b and output an intervention request in response to the states of the work machines 1a and 1b. The intervention request includes first to fourth requests.

The first request is a failure of the work machine 1a or 1b. For example, the machine controller 26a detects a failure of the engine 22 from the temperature of the cooling water of the engine 22. Alternatively, the machine controller 26a detects a failure of the travel device 12 or the work implement 13 from the hydraulic pressure or the hydraulic temperature in a hydraulic circuit. The second request is that the remaining amount of fuel is low. For example, the machine controller 26a determines that the remaining amount of fuel is low when the remaining amount of fuel reaches a predetermined threshold or less.

The third request is an abnormal state of the work machine la or 1b. For example, the machine controller 26a detects an abnormal state of the first work machine 1a from the machine tilt data. The machine controller 26a detects the abnormal state of the first work machine 1a when the roll angle of the vehicle body 11 is equal to or greater than a predetermined angle threshold.

The fourth request is a reduction of workability. For example, the machine controller 26a detects a reduction of workability from the amount of excavated soil. The machine controller 26a calculates the amount of excavated soil from the load taken on by the work implement 13. Alternatively, the machine controller 26a calculates the amount of excavated soil from changes in the actual topography 80.

When the remote controller 2 has received the intervention request from at least one of the plurality of work machines 1a and 1b, the routine advances to step S203. In step S203, the remote controller 2 stops the automatic operation of the work machine that has output the intervention request among the plurality of work machines 1a and 1b. For example, when the remote controller 2 receives an intervention request from the first work machine 1a while the first work machine 1a and the second work machine lb are operating automatically, the remote controller 2 stops the automatic operation of the first work machine 1a and causes the first work machine la to stand still.

In step S204, the remote controller 2 enables the manual operation. The remote controller 2 activates the manual operation with the operating device 5 on the work machine that outputted the intervention request among the plurality of work machines 1a and 1b. For example, when the remote controller 2 has received an intervention request from the first work machine 1a, the remote controller 2 activates the manual operation with the operating device 5 for the first work machine 1a. Consequently, the first work machine 1a is switched from the automatic operating mode to the manual operating mode.

In the manual operating mode, the first work machine 1a is controlled in response to operation signals from the operating device 5. The operating device 5 outputs an operation signal corresponding to an operation by the operator. The remote controller 2 transmits the operation signal to the first work machine 1a. The machine controller 26a of the first work machine 1a receives the operation signal. The machine controller 26a controls the first work machine 1a in accordance with the operation signal. Consequently, the operator is able to remotely operate the first work machine 1a by operating the operating device 5.

In step S205, the remote controller 2 determines whether the work machine in the manual operating mode has met a reactivation condition. The reactivation condition includes first to third conditions. The first condition is that the work machine in the manual operating mode has returned to the starting point of the previous excavation. For example, the remote controller 2 determines whether the first work machine 1a has returned to the starting point of the previous excavation from the first position data of the first work machine 1a.

The second condition is that there is no manual operation over a predetermined time period. The remote controller 2 determines whether there is no manual operation over a predetermined time period from the operation signals of the operating device 5. The third condition is that a reactivation command has been issued by the operator. The remote controller 2 determines the presence or absence of the reactivation command from the operator based on an operation signal of the input device 3. When the work machine in the manual operating mode has met the reactivation condition, the routine advances to step S206.

In step S206, the remote controller 2 reactivates the automatic operation of the work machine in the manual operating mode. For example, when the first work machine 1a in the manual operating mode has met the reactivation condition, the remote controller 2 reactivates the automatic operation of the first work machine 1a. Consequently, the first work machine la restarts the abovementioned automatic operation. The manual operation for the first work machine 1a is disabled by repeating the processing from step S201.

In the control system of the work machines 1a and 1b according to the present embodiment explained above, the plurality of work machines 1a and 1b can be operated remotely by using the operating device 5. In addition, when the first work machine 1a and the second work machine 1b operate automatically, the operation of the operating device 5 on the first work machine 1a is disabled. Consequently, a reduction in work efficiency due to an unnecessary operation can be prevented.

Although an embodiment has been described so far, the present invention is not limited to the above embodiment and various modifications may be made within the scope of the invention. The work machines 1 and 1b are not limited to bulldozers and may be another type of machine such as a wheel loader or a motor grader and the like. The work machines 1a and 1b may be vehicles driven by an electric motor.

The remote controller 2 may have a plurality of controllers separate from each other. The abovementioned processing of the remote controller 2 may distributed and executed among the plurality of controllers. The machine controller may have a plurality of controllers separated from each other. The abovementioned processing of the machine controller may distributed and executed among the plurality of controllers. The abovementioned processing may distributed and executed among the plurality of processors.

The processing of the automatic operation and the processing for switching from the automatic operating mode to the manual operating mode are not limited to the above embodiment and may be changed, omitted, or other processes may be added. The execution sequences of the processing of the automatic operation and the processing for switching from the automatic operating mode to the manual operating mode are not limited to the above embodiment and may be changed. Some of the processing of the machine controllers may be executed by the remote controller 2. Some of the processing of the remote controller 2 may be executed by the machine controllers. For example, the processing for disabling the manual operation may be executed respectively by the machine controllers of the work machines 1a and 1b.

The automatic operation of the work machines 1a and 1b may be fully automatic or may be partially automatic. For example, the work implements of the work machines 1a and 1b may be controlled automatically according to the target design topography 84, and traveling such as forward travel, reverse travel, or turning of the work machines 1a and 1b during the automatic operation may be controlled manually in accordance with the operation of the operating device 5.

In the above embodiment, the automatic operation of the work machine that has issued the intervention request is stopped and the manual operation of said work machine is enabled. However, the remote controller 2 may stop the automatic control of the work machine that issued the intervention request and may issue an alert that said work machine has issued the intervention request. For example, the remote controller 2 may display the alert on the display 4. In this case, the remote controller 2 may maintain the manual operation of the work machine that issued the intervention request in a disabled state.

According to the present disclosure, an operator is able to use an operating device to remotely operate a plurality of work machines that are able to move automatically and also a reduction in work efficiency due to an unnecessary operation can be prevented.

1. A system comprising:
a plurality of work machines that are operable automatically, the plurality of work machines including a first work machine and a second work machine;
a communication device configured to communicate wirelessly with the plurality of work machines;
an operating device configured
to transmit an operation signal to the plurality of work machines via the communication device and
to operate the plurality of work machines remotely and individually; and
a controller configured to disable an operation of the first work machine by the operating device when the first work machine and the second work machine are operating automatically.

2. The system according to claim 1, wherein
each of the plurality of work machines is configured to
detect a state of the work machine and
output an intervention request with respect to the operating device in accordance with the state of the work machine, and
the controller is configured to activate the operation of the first work machine by the operating device when receiving the intervention request from the first work machine.

3. The system according to claim 1, wherein
each of the plurality of work machines is configured to
detect a state of the work machine and
output an intervention request with respect to the operating device in accordance with the state of the work machine; and
the controller is configured to stop an automatic operation of the first work machine when receiving the intervention request from the first work machine.

4. The system according to claim 3, wherein
the controller is configured to reactivate the automatic operation of the first work machine when the first work machine the automatic operation of which is stopped satisfies a predetermined reactivation condition.

5. A method for controlling a plurality of work machines that are operable automatically, the plurality of work machines including a first work machine and a second work machine, the method comprising:
transmitting an operation signal to the plurality of work machines from an operating device configured to operate the plurality of work machines remotely;
determining whether the first work machine and the second work machine are operating automatically; and
disabling an operation of the first work machine by the operating device when the first work machine and the second work machine are operating automatically.

6. The method according to claim 5, further comprising:
determining whether an intervention request with respect to the operating device has been received from the first work machine; and
activating the operation of the first work machine by the operating device when the intervention request for the operating device is received from the first work machine.

7. The method according to claim 5, further comprising:
determining whether an intervention request with respect to the operating device has been received from the first work machine; and
stopping an automatic operation of the first work machine when the intervention request is received from the first work machine.

8. The method according to claim 7, further comprising:
reactivating the automatic operation of the first work machine when the first work machine the automatic operation of which is stopped satisfies a predetermined reactivation condition.
